(19) United States
(12) Patent Application Publication
(10) Pub. No.: US 2021/0138338 A1
(43) Pub. Date: May 13, 2021

(54) Yuyu Hakusho Vs Rurouni Kenshin Ante Litterem S

(71) Applicant: Arnes Becirovic, Grand Rapids, MI (US)

(72) Inventor: Arnes Becirovic, Grand Rapids, MI (US)

(21) Appl. No.: 16/680,246

(22) Filed: Nov. 11, 2019

(51) Int. Cl. A63F 13/00

(52) U.S. Cl. CPC A63F 13/00

(57) ABSTRACT

The Present invention is directed to a method and system for virtual reality data stimulation. Whereby a consumer may operate a technical system of seventy four playable characters wherein the C++ Programming language and technical software game engine technology allow for internal design, Level creation and computer Programming data transformation within a computer server. A slight Sequence between software licensing data transformation and engineering a chain reaction software blueprint is held within the python scripting and data terminal source code. A System of a limitless extensibility. An engineered computer software apparatus, comprising of a manipulated spectrum of video game characters and space terminology. Prototyping architecture code and server code allow for multiple representations of the binary circuit towards the consumer.

### BACKGROUND OF THE INVENTION/UNITY OF INVENTION

### The Field of the Invention

The Invention Yuyu Hakusho vs Rurouni Kenshin Ante Litterem S Generally relates to the Yuyu Hakusho Series illustrated by Yoshihiro Togashi. It also features the Rurouni kenshin series illustrated by Nobuhiro Watsuki. Yuyu Hakusho vs Rurouni Kenshin Ante Litterem S Features 63 Characters, along with 10 Bonus Characters that may be unlocked.

### Background of the Prior Art

The Professional Art was created by Arnes Becirovic, and the professional Art will be used inside the final prototype if possible. Character designers need to have technical skills in both computer-design programs and visual art. Some animation and coding skills don't hurt, but they're not as necessary to the profession.

When it comes to visual art, I have a solid grasp of anatomy and physiology along with a creative imagination to boot. But in order for characters to move around and function in the game world, they need to have physically sound body proportions. Adobe illustrator and Photoshop along with Pixlr photo editor must be mastered in order for me to take on this task. A Basic grasp of Human Psychology Behavior traits along with Character Design has to be incorporated in order to create all of the characters inside the final playable Prototype. I have to create all of the video game characters along with all of the Fighting arenas using the Unreal Engine Software by Epic games. Unreal Engine 4 should give me the Ability to create the final Software, Create film-quality levels of VFX polish with completely customizable particle systems in the built-in Niagara and Cascade visual effects editors. Unreal Engine provides the highest-quality solution for creating virtual reality (VR), augmented reality (AR), and mixed reality (MR) experiences. Unreal Engines LOD system will let me Create large open-world environments with the Landscape system. A powerful LOD system and efficient memory use make massive-scale landscapes achievable. Rendering and Graphics along with Chaos Destruction allow me to Create Artificial Intelligence inside my game. Multiple systems working together inside the software such as Behavior Trees, Environmental query system, Ai perception and AI Debugging allow me to create the characters that I need to make the Prototype a Reality. Unreal Engine Features 32 Tools and Systems for Video game Creation that I will use to create my Final Prototype patent software. Unreal Audio engine allows me to enhance my project's audio with revolutionary features including real-time synthesis, dynamic DSP effects, and physical audio propagation modeling. Unreal Engine 4 by Epic games should allow me to ship my final project to my end user without obstruction.

No Cross Reference to Related Applications

### BRIEF SUMMARY OF THE INVENTION/BRIEF DESCRIPTION OR DRAWINGS

### 608.01(d) Brief Summary of Invention/37 CFR 1.73

The nature of Yuyu Hakusho vs Rurouni Kenshin Ante Litterem S Prototype Software Utility Patent with a gameplay layout designed by Unreal Engine 4/Epic games

Operation/Civil law—The final prototype is a form of intellectual property that gives me the owner the legal right to exclude others from making, using, selling and importing an invention for a limited period of years. In exchange for publishing and enabling public disclosure of the final prototype, I will sell the final prototype to an End User publishing company using an End user Licensing Agreement along with 4 pieces of intellectual property contract. These pieces of contract are Assignment of Rights patent issued, Assignment of Intellectual property rights, Intellectual property assignment agreement and a nondisclosure agreement.

Purpose of the invention—The purpose of Yuyu Hakusho vs Rurouni Kenshin Ante Litterem S is to entertain the Weekly Shōnen Jump manga anthology published in Japan by Shueisha with a Video game stimulus threshold on the PlayStation 4 and Xbox. Nothing will give these fans more of a rush then to able to fight with their Favorite Characters from the Yuyu Hakusho and Rurouni Kenshin japan manga Series on a Visual Video game Threshold Stimulus.

1. A Method and system of virtual reality Stimulation containing an abstract reality of Japanese entertainment within a virtual reality circuit comprising the programmed steps of:
(a) A manipulated data System of Seventy four playable Characters using a unified modeling language engineering platform. Certain statutory rights are given to the creators and their assigns, including the right to control the distribution of their creative works.
(b) The method for engineering the system of claim 1, further comprising the steps of using C++ Programming language towards the prototype.
(c) The method for Technical Software Engineering the product of claim 1, further comprising the step of refactoring the binary code.
(d) The method of Game Engine software constructing the system of claim 1, further comprising the steps of LOD and Chaos destruction towards the End license.
(e) The method of Design, Level creation and computer Programming the data transformation of claim 1, further comprising the step of final prototype architecture.
(f) Original Sound recordings that contain certain musical composition that comes from certain compact disc, vinyl disk, open reel tape and cassette tapes.
(g) Restricting general public access to the intellectual property product-barring the content provider from pretending to be said consumer.
(h) The method for the distribution of the prototype of claim 1, further comprising the step of entering into a licensing agreement with the assignee of the intellectual property rights associated with said digital product.
In the Domestic free market distribution channel, I am seeking substantial protection for the ability to manufacture a Fighting game that contains the characters from Yuyu Hakusho and Rurouni Kenshin. The apparatus contains the preferred protection of the final manufactured intrinsic software prototype invention. I prefer to protect the intellectual property rights inside the Nonprovisional utility patent Yuyu Hakusho vs Rurouni Kenshin Ante Litterem S. I am claiming the domestic protection of this technological system of occurrence. I prefer to protect the technological background behind my Yuyu Hakusho vs Rurouni Kenshin Ante Litterem S prototype Invention. A System of Cooperating apparatus, an apparatus comprising of a video game system of characters. (FIGS. 2-4) The agent is completely original and there has never been a concept such as this.
